(19) United States
(12) Patent Application Publication
(10) Pub. No.: US 2025/0291807 A1
(43) Pub. Date: Sep. 18, 2025

(54) USING MULTIMODAL INPUT AND MULTIPLE LIGHTWEIGHT MODELS TO IMPROVE QUERY RESPONSES

(71) Applicant: Microsoft Technology Licensing, LLC, Redmond, WA (US)

(72) Inventors: David Earl WASHINGTON, Saint Paul, MN (US); Chaitanya GUPTA, Haryana (IN); Kamal GINOTRA, Kirkland, WA (US); Ashish RAJVANSHI, Uttar Pradesh (IN); Danielle Tene CHMIEL, Seattle, WA (US); Radhika AGRAWAL, Uttar Pradesh (IN); Lakshay TUTLANI, New Dehli (IN); Mark Robert BOLIN, Carnation, WA (US); Michael Lawrence VALENZUELA, Yelm, WA (US); Andrew Lawrence STEWART, Ontario (CA)

(21) Appl. No.: 18/827,244

(22) Filed: Sep. 6, 2024

(30) Foreign Application Priority Data
Mar. 13, 2024 (IN) 202411018056

(51) Int. Cl. G06F 16/248; G06F 16/245

(52) U.S. Cl. CPC G06F 16/248; G06F 16/245

(57) ABSTRACT

This disclosure describes a lightweight image query system that utilizes multiple lightweight models to quickly and efficiently generate responses to multimodal input queries. For example, in response to a multimodal input query, the lightweight image query system utilizes multiple lightweight context models to first obtain different types of context information based on the different input modes. The lightweight image query system then utilizes a lightweight large generative model (LGM) to quickly generate a query response using the different types of context information. By using lightweight models, including multiple lightweight context models and a lightweight LGM, the lightweight image query system can efficiently provide query responses to multimodal input queries in about half the time it takes conventional systems to return a query response.

### CROSS-REFERENCE TO RELATED APPLICATIONS

This application claims priority to and the benefit of Indian Provisional Patent Application No. 202411018056, filed Mar. 13, 2024, which is hereby incorporated by reference in its entirety.

### BACKGROUND

Search engine services have significantly enhanced the ability to explore websites across the vast expanse of the Internet. More recently, advanced chat services utilizing artificial intelligence (AI), known as large generative models (LGMs), including large language models (LLMs), have emerged. In some cases, LGMs use machine learning models to provide information about different modes of user-submitted content. Despite these and other recent advancements, LGMs still suffer from various shortcomings.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of implementing a lightweight image query system that uses one or more lightweight models to generate query responses to queries based on multimodal input.

FIG. 2 illustrates an example computing environment in which the lightweight image query system is implemented in a cloud computing system.

FIGS. 3A-3C illustrate example graphical user interfaces for providing query responses on a client device in response to a multimodal input query request.

FIGS. 4A-4B illustrate example block and sequence flow diagrams for using multiple lightweight models to respond to a multimodal input query request.

FIG. 5 illustrates an example workflow diagram of using a lightweight and a heavyweight image metadata model to obtain grounding information for an image.

FIGS. 6A-6C illustrate example block and sequence flow diagrams for using multiple lightweight models and optionally, a heavyweight context model, to respond to a multimodal input query request.

FIG. 7 illustrates an example sequence flow diagram for using multiple lightweight models and a heavyweight context model to respond to a multimodal input query request.

FIG. 8 illustrates an example series of acts in a computer-implemented method for responding to multimodal input queries within a threshold time by using multiple lightweight models.

FIG. 9 illustrates another example series of acts in a computer-implemented method for responding to multimodal input queries within a threshold time by using multiple lightweight models.

FIG. 10 illustrates example components included within a computer system for implementing a lightweight image query system.

### DETAILED DESCRIPTION

This disclosure describes a lightweight image query system that utilizes multiple lightweight models to quickly and efficiently generate responses to multimodal input queries. For instance, in response to a multimodal input query, the lightweight image query system utilizes multiple lightweight context models to first obtain different types of context information based on the different input modes. For example, the lightweight image query system concurrently provides the different input portions of the multimodal input to different lightweight context models to obtain different types of context information (e.g., semantic and environmental information). The lightweight image query system then utilizes a lightweight large generative model (LGM) to quickly generate a query response using the different types of context information. By using lightweight models, including multiple lightweight context models and a lightweight LGM, the lightweight image query system can efficiently provide query responses to multimodal input queries in about half the time it takes conventional systems to return a query response.

Indeed, implementations of the present disclosure provide benefits and solve problems in the art with systems, computer-readable media, and computer-implemented methods that utilize a lightweight image query system to quickly and efficiently respond to multimodal input queries. As mentioned, compared to existing systems, by using lightweight models, including some models concurrently, the lightweight image query system responds to multimodal input queries that include both audio and images in around 10 seconds while existing systems often take longer than 20 seconds. Furthermore, when improved accuracy is needed to respond to a query request, the lightweight image query system also leverages additional models to provide accurate answers to multimodal input queries.

To elaborate, in various implementations, the lightweight image query system obtains a multimodal input that includes two input portions differing in their input modes. For the first input portion in the first mode, the lightweight image query system provides it to a first context model (e.g., a first lightweight context model) specialized in processing inputs in a first mode. Similarly, the lightweight image query system provides the second input portion in the second mode to a second context model specialized in processing inputs in a second mode. Using a first output from the first context model that includes semantic information and a second output from the second context model that includes grounding information, the lightweight image query system generates and provides a query prompt to a lightweight LGM, which generates a response with the provided information. The lightweight image query system then provides the query response in answer to the multimodal input query.

As another example, in one or more implementations, the lightweight image query system captures a multimodal input query that includes an audio input portion and an image input portion. In some of these implementations, the lightweight image query system sends the audio input portion to a speech-to-text model (e.g., a lightweight context model) to generate semantic information in the form of converted text. The lightweight image query system also sends the image input portion to a lightweight image metadata model to generate image grounding information. The lightweight image query system generates a query prompt from the semantic information and the image grounding information and provides the prompt to a lightweight LGM (e.g., a text-based LGM), which generates a query response. The lightweight image query system then provides the query response in answer to the multimodal input query.

Additional examples of the lightweight image query system using multiple lightweight context models and a lightweight LGM are provided below.

As mentioned above, LGMs suffer from various shortcomings. For instance, some existing systems inefficiently handle multimodal inputs. For example, for a query request that includes two input modes, some existing systems send all of the inputs to a heavyweight LGM (e.g., multimodal heavyweight LGM trained to handle a large number of input modes). While the heavyweight LGM is capable of answering the request, it uses many expensive and unnecessary computer operations to process each input mode and arrive at an answer. These inefficiencies are often manifested by the length of time needed to generate and return a response. Furthermore, in a heavyweight LGM, both simple and complex multimodal input queries require a heavy operational load to answer.

In some instances, for a multimodal input query that includes two input modes, existing systems provide an input of the first mode to a first LGM model and await a response. The system then sends the output from the first LGM model along with the second input of the second mode to another LGM to generate a response. While this approach also requires expensive computing operations to execute multiple LGM models, it also includes an additional waiting time for some processes to complete before others can begin.

Additionally, when one of the multimodal inputs is an image, some existing systems that use heavyweight LGMs (e.g., generic one-size-fits-all LGMs) to provide image-based information provide inaccurate information. This is despite taking long periods to return information. Again, many existing systems default to using heavyweight LGMs to provide image-based information (e.g., image grounding information) even if minimal grounding information is needed to answer a query request, which requires large amounts of computing resources.

In contrast to existing systems, as described in this disclosure, the lightweight image query system delivers several significant technical benefits in terms of computing accuracy and efficiency. Moreover, the lightweight image query system provides several practical applications that address problems related to accurately and efficiently generating multiple text query responses using various large generative models and grounding information.

To illustrate, the lightweight image query system provides several technical benefits, including improved efficiency, accuracy, and flexibility when answering multimodal input queries. For example, in one or more implementations, based on receiving a multimodal input query, the lightweight image query system utilizes multiple lightweight context models to obtain context information (e.g., semantic and grounding information) for the different input portions of the multimodal input. By using lightweight context models to obtain context information for the query request, computing operations are significantly reduced. Additionally, the lightweight image query system often calls these multiple lightweight context models concurrently to minimize wait times.

Using lightweight context models to obtain context information improves computing efficiency by obtaining similar information with less processing costs. The lightweight image query system further improves efficiency by using a lightweight LGM, such as a text-based LGM, to generate query responses from prompts that include the context information (e.g., the semantic and grounding information) obtained from the multiple lightweight context models. The lightweight LGM is significantly more efficient than LGMs. To illustrate, by using multiple models concurrently as well as a lightweight LGM, the lightweight image query system can provide query responses to multimodal input queries in under ten seconds, while conventional systems that use LGMs often take over twenty seconds to return a similar query response.

In various implementations, the lightweight image query system provides improved accuracy. For example, in some implementations, the lightweight LGM determines that it needs more information to correctly answer a query request. In these instances, the lightweight image query system may also prompt a visual-based LGM (e.g., a specialized heavyweight LGM with a focus on determining grounding information) to provide additional image grounding information. In some cases, the lightweight image query system provides this prompt concurrently with the multiple lightweight context models. This way, when the lightweight LGM determines that it needs additional information to accurately answer the query request, the lightweight image query system can quickly provide the additional grounding information. In some instances, to save on computing costs, the lightweight image query system does not obtain additional grounding information until needed by the visual-based LGM.

As a further technical benefit, the lightweight image query system flexibly operates with the multiple lightweight context models described above that provide context information for the query request. For example, based on the types of input modes in the multimodal input, the lightweight image query system flexibly determines which lightweight context models to call. In some instances, the lightweight image query system provides an input portion to multiple lightweight context models to obtain multiple output instances (e.g., the lightweight image query system obtains image grounding information from several lightweight context models).

As illustrated in the foregoing discussion, this disclosure utilizes a variety of example terms to describe the features and advantages of one or more implementations. For instance, this disclosure describes the lightweight image query system in the context of a cloud computing system. As an example, the term “cloud computing system” refers to a network of interconnected computing devices that provide various services and applications to computing devices (e.g., server devices and client devices) inside or outside of the cloud computing system. While various components are described as belonging to a cloud computing system, in some implementations, one or more components are located outside of the cloud computing system. Additional terms are defined throughout the document in different examples and contexts.

As an example, the term “lightweight model” refers to a compact and resource-efficient model that is trained to perform a specific task while achieving a balance between accuracy and computational cost. For example, while an LGM is trained on vast datasets to solve a wide range of tasks, a lightweight model is often targeted to one or a few tasks. In various implementations, a lightweight model is a machine learning model. In some implementations, a lightweight model is a heuristics-based or algorithmic model. Lightweight models are designed to perform specific tasks while minimizing memory usage, inference time, and energy consumption. Lightweight models use significantly fewer parameters and computing processing resources than many LGMs to provide outputs.

As another example, the term “lightweight context model” refers to a lightweight model that generates context information for a query request based on inputs (or input portions) provided in the query request. To illustrate, examples of lightweight context models include speech-to-text models, search engine models, image metadata models, image classification models, similar image search models, object detection models, image segmentation models, text recognition models, and visual search image models. Unless otherwise stated, the term “lightweight model” refers to a lightweight context model and the term (e.g., a text-based LGM).

As another example, the term “lightweight large generative model” (or “lightweight LGM”) refers to a query-answering model that generates query responses upon receiving prompts. Examples of lightweight LGMs include a text-based LGM (e.g., a non-image-based LGM) and lightweight language models.

As another example, the term “large generative model” (LGM) refers to an artificial intelligence system with billions or trillions of parameters that uses deep learning to produce coherent and contextually relevant text based on patterns learned from large amounts of training data. In various implementations, a generative learning model, such as a multi-modal generative model, refers to an advanced computational system that uses natural language processing, machine learning, and/or image processing to generate coherent and contextually relevant human-like responses. In some examples, a “heavyweight LGM” refers to an LGM that accepts images and/or multimodal inputs, such as a visual-based LGM.

As mentioned above, large generative models have a large number of parameters (e.g., in the billions or trillions) and are trained on a vast dataset to produce fluent, coherent, and topic-specific outputs (e.g., text and/or images). Large generative models have applications, including natural language understanding, content generation, text summarization, dialog systems, language translation, creative writing assistance, and image generation. A single large generative model performs a wide range of tasks based on different inputs, such as prompts (e.g., input instructions, rules, example inputs, example outputs, and/or tasks), data, and/or access to data. In response, the large generative model generates various output formats ranging from one-word answers to long narratives, images and videos, labeled datasets, documents, tables, and presentations.

Large generative models include large generative language models (LGLMs) (a.k.a. simply “large language models” (LLMs)), which are primarily based on transformer architectures to understand, generate, and manipulate human language. LLMs can also use a recurrent neural network (RNN) architecture, long short-term memory (LSTM) model architecture, convolutional neural network (CNN) architecture, or other architecture types. Examples of LLMs include generative pre-trained transformer (GPT) models such as GPT-3.5 and GPT-4, bidirectional encoder representations from transformers (BERT) models, text-to-text transfer transformer models such as T5, conditional transformer language (CTRL) models, and Turing-NLG. Other types of large generative models include sequence-to-sequence models (Seq2Seq), vanilla RNNs, and LSTM networks.

Large generative models include visual-based large generative models (LGM-V). Visual-based LGMs generate visual image grounding information from an input image. For instance, a visual-based LGM could use a combination of convolutional neural networks (CNNs) and transformers to generate high-quality visual content and/or extract visual features from the input image.

As an example, the term “multimodal input” refers to the combination of multiple modes of data provided in a single input. For example, multimodal input includes two or more modes of data captured simultaneously as input. In many cases, different modes of data within a multimodal input are referred to as input portions (e.g., a first input portion and a second input portion). Modes of data in a multimodal input can include various forms, such as audio (e.g., speech), images (including videos), text, or sensor data. The terms “first mode” and “second mode” refer to different modes of data in a multimodal input. In some instances, a multimodal input might include spoken audio captured in connection with an image.

As an example, the term “prompt” refers to a query or input provided to an LGM (e.g., a lightweight LGM or a visual-based LGM) that provides instructions, directions, guidelines, and/or parameters for generating an answer or result. A prompt may include carefully selected parameters determined based on various factors, such as available input information and desired output data format. In some implementations, a prompt includes and/or references additional information being provided to a large generative model. Additional examples of prompts, including system-generated prompts, are provided below.

As another example, the terms “query response” or “response” refer to the generated output produced by an LGM (e.g., a lightweight LGM or a visual-based LGM) in reaction to a given prompt. A response can take various forms, such as natural language text, images, or other structured data. In various implementations, a lightweight LGM generates crisp and/or shortened responses. For example, a lightweight LGM provides the lightweight image query system with a response that directly answers the query request without providing additional answers to related queries or without including additional metadata that will not be provided to the user in response to the query request.

As an example, the term “semantic information” refers to the meaningful content extracted from an input portion of a multimodal input for providing context to a query request. For example, for an audio input portion of captured speech, the semantic information provides the essence of what was spoken, including words, phrases, and context. Semantic information provides an understanding of a user's intent needed to generate accurate responses to query requests. In some instances, semantic information may complement other context information obtained from other input portions, such as grounding information obtained from visual sources (such as images).

As another example, the term “grounding information” refers to a set of visual information associated with an image (e.g., an input image provided by a user) that provides context to a query request. Grounding information provides environment context information for an image based on processing and analyzing the image. In some instances, grounding information is extracted directly from an image (sometimes called image grounding information), such as visual image grounding information. For example, image grounding information may include relevant identified objects or regions in an image text, image metadata, and/or other image information.

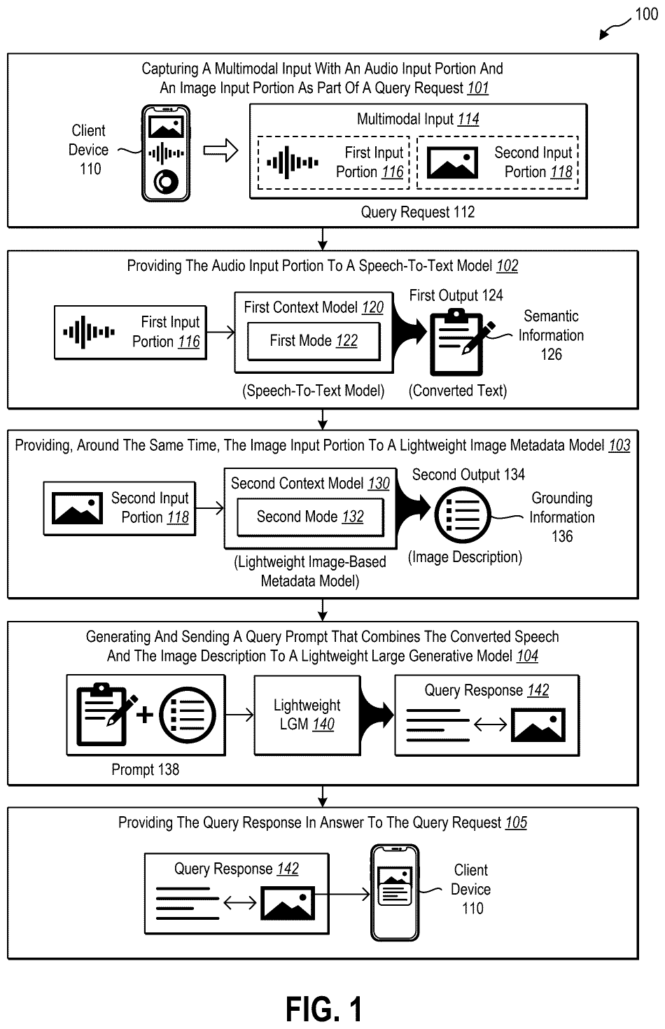

Additional example implementations and details of the lightweight image query system are discussed in connection with the accompanying figures, which are described next. For example, FIG. 1 illustrates an overview of implementing a lightweight image query system that uses one or more lightweight models to generate query responses to queries based on multimodal input according to some implementations. As shown, FIG. 1 illustrates a series of acts 100 performed (or caused to be performed) by the lightweight image query system.

For context, some cloud computing systems answer query responses requested by users. For example, a cloud computing system provides a chat-based user interface that allows users to submit a range of questions and receive well-formulated answers. In some instances, the cloud computing system provides user interfaces (e.g., within a software application) to facilitate query responses. For instance, a client device includes a user interface that allows a user to submit a query request via multiple input modes. In some instances, such as the implementations described in this disclosure concerning the lightweight image query system, the user interface allows the client device to receive multimodal input for a query request.

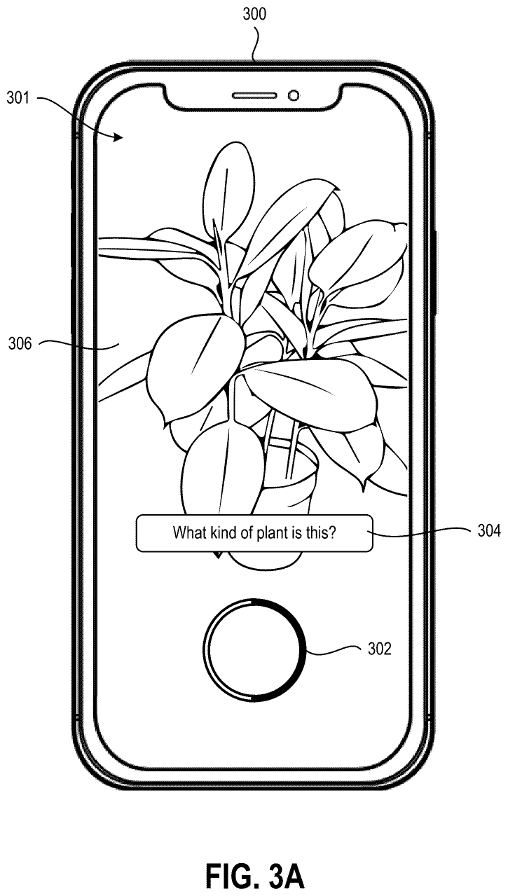

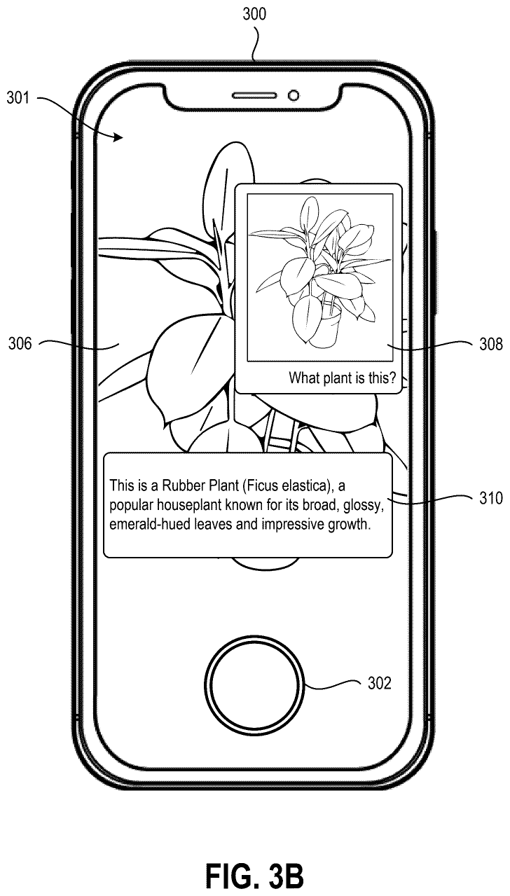

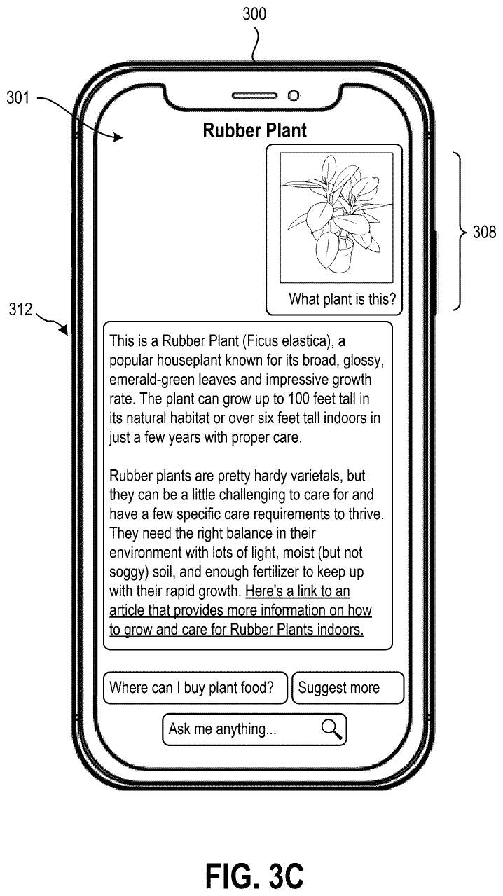

As shown, the series of acts 100 includes act 101 of capturing a multimodal input with an audio input portion and an image input portion as part of a query request. Broadly speaking, the lightweight image query system receives multimodal input 114 from a client device 110 as part of a query request 112 where the multimodal input 114 includes a first input portion 116 and a second input portion 118. For example, the first input portion 116 includes audio and the second input portion 118 includes an image, each captured by the client device 110, often at the same time. Additional details regarding capturing multimodal input for a query request are provided below in connection with FIG. 3A.

Act 102 includes the lightweight image query system providing the audio input portion to a speech-to-text model. As shown, the lightweight image query system provides the first input portion 116 to a first context model 120 specialized in processing inputs of a first mode 122 (e.g., a speech-to-text model that processes audio). Additionally, the first context model 120 generates a first output 124, which can include converted text or another type of output, depending on the model and the mode. The first output 124 includes semantic information 126, which provides context about the query request.

Act 103 includes providing, around the same time, the image input portion to a lightweight image metadata model. As shown, the lightweight image query system provides the second input portion 118 to a second context model 130 specialized in processing inputs of a second mode 132 (e.g., a lightweight image metadata model that processes images). In various instances, the lightweight image query system provides the first input portion 116 and the second input portion 118 to the respective models at or around the same time (e.g., concurrently). The second context model 130 generates a second output 134 that includes grounding information 136, which also provides context to the query request (e.g., an image description having environment information).

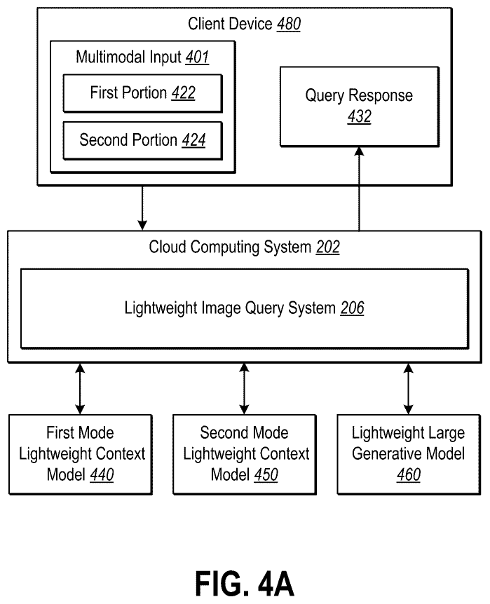

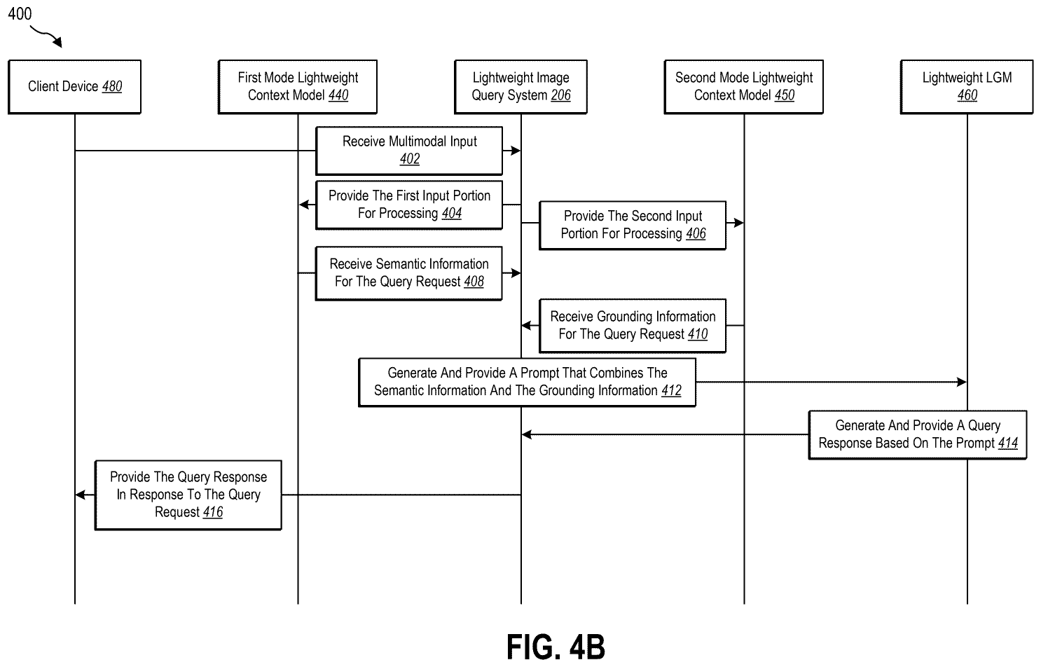

Notably, the first context model 120 and the second context model 130 are lightweight context models that generate context (e.g., semantic and environment information, including grounding information) for a query request. In some instances, the lightweight context models include lightweight machine learning models. In some instances, the models include heuristic-based models, as described above. In particular, the first context model 120 and the second context model 130 are trained to efficiently process data of particular modes and perform specific tasks to achieve targeted outputs. Additional details regarding lightweight context models are provided below in connection with FIGS. 4A-4B, FIG. 5, and FIGS. 6A-6C.

Act 104 includes generating and sending a query prompt that combines the converted speech and the image grounding information to a lightweight large generative model. As shown, the lightweight image query system provides a prompt 138 to a lightweight LGM 140 to generate a query response 142 based on the context information included in the prompt 138. For example, the lightweight image query system generates a prompt that includes the semantic information 126 and the grounding information 136 obtained from the lightweight context models, then sends it to the lightweight LGM 140 as part of a query prompt.

In response to receiving the prompt 138, the lightweight LGM 140 processes the query request based on the context information and generates the query response 142. In some instances, as described below, the lightweight LGM 140 may need additional context information, which the lightweight image query system obtains. The lightweight LGM 140 returns the query response 142 to the lightweight image query system. The lightweight image query system provides the query response to the client device in answer to the query request, as shown in act 105. Additional details regarding providing a query response to a client device are provided below in connection with FIG. 3B.

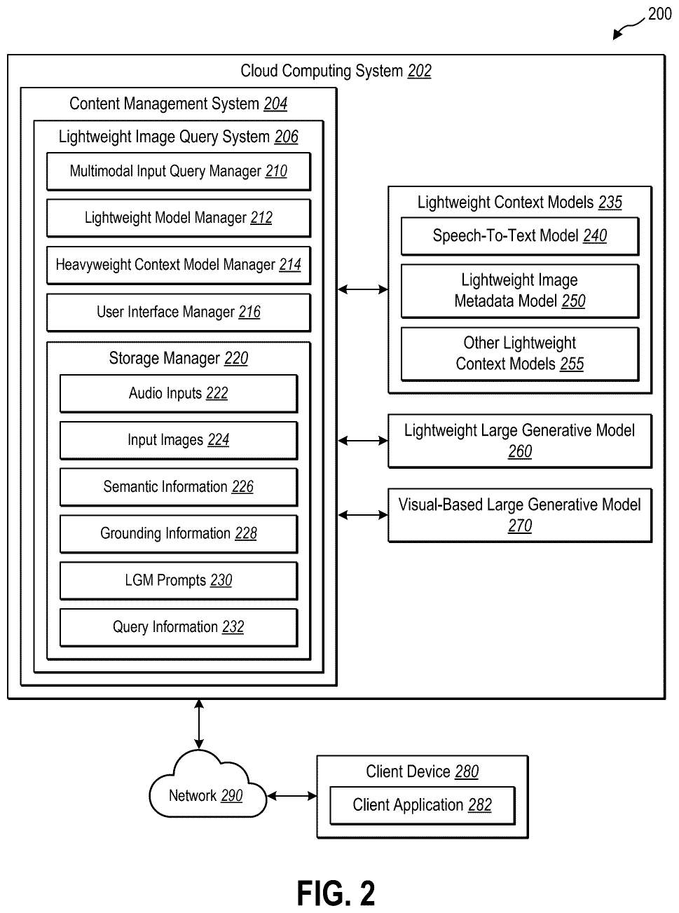

With a general overview in place, the next figure provides a general overview of the components, features, and elements of the lightweight image query system. To illustrate, FIG. 2 shows an example computing environment where the lightweight image query system is implemented in a cloud computing system according to some implementations. In particular, FIG. 2 shows an example of a computing environment 200 with various computing devices within a cloud computing system 202 associated with a lightweight image query system 206. While FIG. 2 shows example arrangements and configurations of the computing environment 200, the cloud computing system 202, the lightweight image query system 206, and associated components, other arrangements and configurations are possible. While the lightweight image query system 206 is shown and described in the context of an image input mode, in some instances, the system is a lightweight query system that processes multimodal input that does not include images.

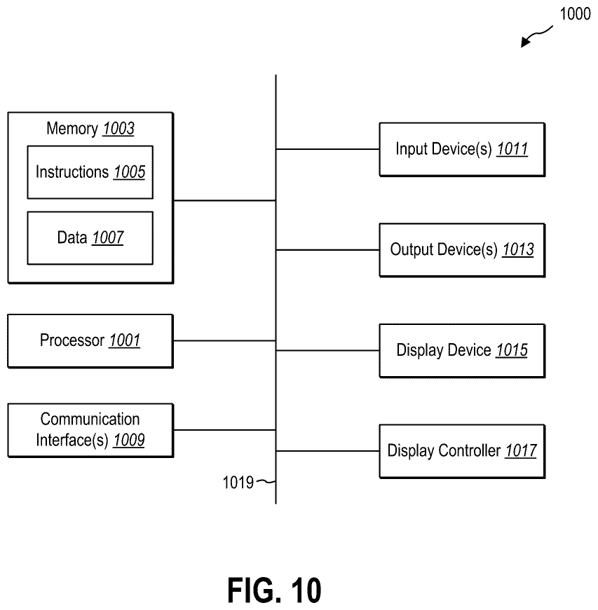

As shown, the computing environment 200 includes a cloud computing system 202 and a client device 280 connected via a network 290. The cloud computing system 202 includes a content management system 204, lightweight context models 235, a lightweight large generative model 260, and a visual-based large generative model 270. The lightweight context models 235 include a speech-to-text model 240, a lightweight image metadata model 250, and other lightweight context models 255. Each of these systems and/or components may be implemented on one or more computing devices, such as on a set of one or more server devices. Further details regarding computing devices are provided below in connection with FIG. 10 along with additional details about networks, such as the network 290 shown.

The content management system 204 performs a variety of functions. In various implementations, the content management system 204 facilitates user interactions with various components and systems of the cloud computing system 202. For example, the content management system 204 facilitates users providing query requests to the cloud computing system 202 and handles the query request using large generative models (not shown) in the cloud computing system 202. The content management system 204 may also implement one or more user interfaces for users to communicate with components and systems of the cloud computing system 202.

As shown, the content management system 204 implements the lightweight image query system 206. Before describing the components of the lightweight image query system 206, other components of the computing environment 200 are first discussed. As shown, the cloud computing system 202 includes the lightweight context models 235, which include the speech-to-text model 240, the lightweight image metadata model 250, and the other lightweight context models 255. In various implementations, the lightweight context models 235 include lightweight models that generate context information based on inputs included in a query request. In some instances, a lightweight context model may process multiple input types and/or be part of a group or chain of lightweight context models that process one or more modes.

To elaborate, in some implementations, the speech-to-text model 240 converts speech within captured audio into a text string, such that the converted text provides semantic information regarding the query request. In various implementations, the lightweight image metadata model 250 generates grounding information (e.g., image grounding information) from input images that describe the image. Because the lightweight image metadata model 250 is lightweight, the model runs quickly and efficiently and only provides image descriptions limited to a few sentences or a single paragraph.

The lightweight context models 235 include the other lightweight context models 255. For example, the other lightweight context models 255 may include additional image-based models that quickly and efficiently extract grounding information from images. In some instances, the other lightweight context models 255 include models that process other input types, such as text, video, tabular data, or sensor data.

As shown, the cloud computing system 202 includes the lightweight large generative model 260, which generates query responses to multimodal input queries based on the context information provided in a query prompt. In some implementations, the lightweight large generative model 260 is a text-based large generative model that quickly and efficiently processes and returns query responses.

As shown, the cloud computing system 202 includes the visual-based large generative model 270, which generates comprehensive grounding information from images. For instance, the visual-based large generative model uses a combination of convolutional neural networks (CNNs) and transformers to generate high-quality visual content and/or extract visual features from the input image. The visual-based large generative model 270 also returns varying levels of image descriptions and grounding information based on the prompt it receives (e.g., a grounding information prompt). In various implementations, the visual-based large generative model 270 is a multimodal model that targets a specific category of grounding information based on a request received in a grounding information prompt.

Returning now to the lightweight image query system 206, which is shown implemented within the content management system 204. In some implementations, the content management system 204 is located on a separate computing device from the content management system 204 within the cloud computing system 202. For example, the lightweight image query system 206 is on another server device, or the lightweight image query system 206 is located wholly or in part on the client device 280.

As mentioned earlier, the lightweight image query system 206 generates query responses to multimodal input queries. As shown, the lightweight image query system 206 includes various components and elements, which are implemented in hardware and/or software. For example, the lightweight image query system 206 includes a multimodal input query manager 210, a lightweight model manager 212, a heavyweight context model manager 214, a user interface manager 216, and a storage manager 220 having audio inputs 222, input images 224, semantic information 226, grounding information 228, LGM prompts 230, and query information 232.

As mentioned above, the lightweight image query system 206 includes the multimodal input query manager 210, which manages receiving, accessing, and handling multimodal input queries. For example, the multimodal input query manager 210 obtains audio inputs 222, input images 224, or other modal input portions from multimodal input queries received from the client device 280. In some implementations, the multimodal input query manager 210 implements returning a generated query response to the client device 280. The multimodal input query manager 210 may store the query requests (e.g., multimodal input queries) and query responses as information 232 within the storage manager 220 to access them when needed.

The lightweight image query system 206 also includes the lightweight model manager 212, which implements communications and instructions with lightweight models, including the lightweight context models 235 and the lightweight large generative model 260. For example, in various implementations, the lightweight model manager 212 provides audio inputs 222 to the speech-to-text model 240 to obtain semantic information 226. In some instances, the lightweight model manager 212 provides the input images 224 to the speech-to-text model 240 to obtain grounding information 228.

Additionally, in some instances, the lightweight model manager 212 generates LGM prompts 230 that include semantic information 226 and grounding information 228 as part of responding to query requests. For example, the lightweight model manager 212 sends the LGM prompts 230 to the lightweight large generative model 260 to obtain query responses. The lightweight model manager 212 may also communicate with the lightweight large generative model 260 to determine when more context information (e.g., grounding information) is needed to answer a query request.

As shown, the lightweight image query system 206 includes the heavyweight context model manager 214. In various implementations, the heavyweight context model manager 214 generates and provides LGM prompts 230 to the visual-based large generative model 270. For example, when additional grounding information is needed, the heavyweight context model manager 214 directly or indirectly provides a grounding information prompt to the visual-based large generative model 270 to obtain additional grounding information to answer a query request.

As shown, the lightweight image query system 206 includes the user interface manager 216. In various implementations, the user interface manager 216 facilitates presenting content, including generative content, to a client device. For example, the user interface manager 216 implements various user interfaces to capture multimodal input as part of a query request and/or to provide a query response. For example, the user interface manager 216 combines the text (and images sometimes) included in a response provided by the lightweight large generative model 260 with one or more of the input portions (e.g., a captured image as the background) to present the query response in an improved manner.

As shown, the computing environment 200 includes the client device 280. In various implementations, the client device 280 is associated with a user (e.g., a user client device), such as a user who interacts with the content management system 204 to request and receive responses to multimodal input queries. For example, the client device 280 includes a client application 282, such as a web browser or another form of computer application for accessing and/or interacting with the content management system 204 and/or lightweight image query system 206 via the network 290.

FIGS. 3A-3C illustrate example graphical user interfaces for providing query responses on a client device in response to a multimodal input query request according to some implementations. In particular, FIGS. 3A-3C illustrate a graphical user interface flow from receiving a multimodal input request (FIG. 3A), providing a query response (FIG. 3B), and providing an enhanced response (FIG. 3C).

FIGS. 3A-3C include a client device 300 that shows a user interface 301. For example, the user interface 301 is provided by a client application associated with a content management system that utilizes the lightweight image query system 206. The lightweight image query system 206 may provide content (e.g., one or more query responses) that causes the client device 300 to update the user interface 301, as described below.

FIG. 3A includes the client device 300 displaying a user interface 301 that includes a multimodal input capture element 302, a captured audio portion 304, and a captured image portion 306. To elaborate, upon a user selecting the multimodal input capture element 302 (i.e., an input element), the lightweight image query system 206 causes the client device 300 to capture both audio input (e.g., using a microphone) and an image input (e.g., using a camera). As shown, the multimodal input capture element 302 includes a progress indicator that shows that input is being captured (e.g., a “live-capture”).

In many implementations, the client device 300 captures a single image. In one or more implementations, the client device 300 captures one or more images and provides some or all of the images to the lightweight image query system 206. In some implementations, the client device 300 captures and provides a video. In these instances, the lightweight image query system 206 may parse out the audio and one or more images as the multimodal input.

In various implementations, upon capturing the audio input, the lightweight image query system 206 uses a lightweight context model (e.g., a speech-to-text model) to convert spoken words into a text string. As shown, the user interface 301 displays some or all of the converted speech in the captured audio portion 304. In various implementations, the lightweight image query system 206 causes the client device 300 to provide some or all of the captured speech in the captured audio portion 304 while additional audio is still being captured (e.g., the multimodal input capture element 302 is still selected and the progress indicator of the multimodal input capture element 302 is still progressing).

As shown, the user interface 301 includes the captured image portion 306. In some implementations, the client device 300 captures an image without immediately displaying the captured image on the user interface 301. For example, the client device 300 continues to display a camera stream. In some instances, the captured image or a similar image is shared along with the response.

The client device 300 can send the multimodal input to the lightweight image query system 206. For example, the client device 300 streams the input or sends partial files to the lightweight image query system 206 while the multimodal input is actively captured. In some implementations, the client device 300 fully captures the multimodal input before sending it to the lightweight image query system 206.

In response, the lightweight image query system 206 generates a query response, as described below in the next set of figures. Upon receiving a query response from a lightweight LGM, the lightweight image query system 206 provides it to the client device 300 to be displayed. To illustrate, FIG. 3B shows the client device 300 updating the user interface 301 to show the query response provided by the lightweight image query system 206.

As shown, the user interface 301 in FIG. 3B includes a copy of the query request 308 and a query response 310. The query request 308 includes the converted text string from the audio input portion and the image from the image input portion of the multimodal input. In some instances, the query request 308 includes a shortened or truncated version of the request submitted by a user.

In various implementations, the query response 310 is displayed in connection with a user interface based on the query request. For example, as shown in FIG. 3B, the background of the chat includes one of the images captured by the multimodal input or is a related image provided by the lightweight image query system 206. In other words, in FIG. 3B, the lightweight image query system 206 provides the query response 310 by generating a visual overlay element that includes the query response and displays the visual overlay element over the image captured by the client device.

In some implementations, the query request received from the lightweight LGM includes text and image links. In response, the lightweight image query system 206 provides the text and image links to the client device 480 with instructions to download images using the links and provide the images in a provided template format. This may be beneficial if the query request includes questions about finding items online.

As shown, the query response 310 includes a shortened response. In many instances, the shortened response highlights provide a direct answer without additional information or answering other questions. Keeping the answers short and crisp allows the lightweight image query system 206 to efficiently return answers to the client device 300 in a short time. In some instances, the lightweight image query system 206 provides one or more additional answers to related or anticipated follow-up queries, which are based on the information (e.g., grounding information) provided by a lightweight context model (and not from context information from a heavyweight LGM).

To contrast the query response 310 provided by the lightweight image query system 206 with a more conventional answer, FIG. 3C shows a typical response to the same query request when submitted as separate input and/or using heavyweight LGMs. As shown, the user interface 301 in FIG. 3C includes the query request 308 and an expanded query response 312. As shown, the expanded query response 312 includes much more information than requested in the query request 308. However, the expanded query response 312 also uses one or more heavier models and takes longer to generate and provide an answer.

In some implementations, the query response 310 in FIG. 3B includes an option for additional information and when selected, provides the expanded query response 312 when available. As described below, the lightweight image query system 206 may use various approaches to determine whether and when to obtain an expanded query response 312. For example, in some instances, the lightweight image query system 206 requests the expanded query response 312 upon receiving the multimodal input in anticipation of the user requesting additional information after receiving the query response 310 or requesting follow-up queries.

As shown, using multimodal input, the lightweight image query system 206 provides a query response in one scenario. Other multimodal input scenarios include a user asking for help cleaning a room (e.g., “Help me clean my room”) along with an image of a messy office, learning about a product (e.g., “What type of product is this”) along with an image of a laptop, instructions to fix an item (e.g., “How do I fix this”) along with an image of a broken bike, discovering the meaning of something (e.g., “laundry machine error code”) along with an image of a laundry machine error code, seeking replacement parts (e.g., “I need to change a bulb on this lamp”) along with a picture of a lamp, or ascertaining important information (e.g., “Does this dish have gluten”) along with a picture of a prepared dish. Indeed, in many instances, the lightweight image query system 206 may use the multimodal input portions synergistically to answer queries where no single input portion by itself would be sufficient.

FIGS. 4A-4B illustrate example block and sequence flow diagrams for using multiple lightweight models to respond to a multimodal input query request according to some implementations. In particular, FIG. 4A includes components and elements involved in generating a query response to a multimodal input query using lightweight models. FIG. 4B shows a sequence diagram that details actions taken by each component included in FIG. 4A to generate a query response to a multimodal input query using lightweight models.

FIG. 4A includes the lightweight image query system 206 implemented on the cloud computing system 202, as introduced above. Additionally, FIG. 4A includes a client device 480, a first mode lightweight context model 440, a second mode lightweight context model 450, and a lightweight LGM 460. These components correspond to similar components introduced in FIG. 2 above. For example, the first mode lightweight context model 440 and the second mode lightweight context model 450 are examples of lightweight context models and broadly correspond to the speech-to-text model 240 and the lightweight image metadata model 250.

As shown, the client device 480 includes a multimodal input 401 with a first portion 422 and a second portion 424. The client device 480 provides the multimodal input 401 to the lightweight image query system 206, for example, as part of a multimodal input query. In response, the lightweight image query system 206 uses the first mode lightweight context model 440 and the second mode lightweight context model 450 to obtain context information for the query request.

The lightweight image query system 206 also uses the lightweight LGM 460 to generate a query response 432, which the lightweight image query system 206 returns to the client device 480, as shown. FIG. 4B provides additional details regarding each of these interactions according to some implementations.

With the components and elements in place, FIG. 4B provides additional detail on how the components interact to generate a query response to a multimodal input query using lightweight models. As shown, FIG. 4B includes communication between the client device 480, the lightweight LGM 460, the first mode lightweight context model 440, the second mode lightweight context model 450, and the lightweight LGM 460.

FIG. 4B includes a series of acts 400 performed by (or for) the lightweight image query system 206. As shown, the series of acts 400 includes act 402 of the lightweight image query system 206 receiving multimodal input from the client device 480. As provided above, the lightweight image query system 206 receives multimodal input that includes multiple input portions, including at least a first input portion in a first mode and a second input portion in a second mode. For example, the multimodal input includes an audio portion and an image portion. In some instances, the multimodal input includes additional and/or other input modes.

Act 404 includes the lightweight image query system 206 providing the first input portion to the first mode lightweight context model 440 for processing. At or around the same time, act 406 includes the lightweight image query system 206 providing the second input portion to the second mode lightweight context model 450 for processing. As mentioned, in various implementations, the lightweight context models perform tasks specialized to a given input mode. For example, the first mode lightweight context model 440 processes inputs of a first input mode while the second mode lightweight context model 450 processes inputs of a second input mode.

Act 408 includes the lightweight image query system 206 receiving semantic information for the query request from the first mode lightweight context model 440 while act 410 includes the lightweight image query system 206 receiving grounding information for the query request from the second mode lightweight context model 450. Semantic information and grounding information are described above and are included as at least part of the context information for the query request.

As shown, the lightweight image query system 206 performs acts 404 and 408 concurrently with acts 406 and 410, meaning at or near the same time. For example, the first input portion is received as an audio stream, and, in response, the lightweight image query system 206 begins providing it to the first mode lightweight context model 440 to obtain converted text. While the converted text is being received from the first mode lightweight context model 440, the lightweight image query system 206 receives the second input, which the lightweight image query system 206 provides to the second mode lightweight context model 450.

Accordingly, in many implementations, concurrent actions include providing one input portion of the multimodal input to a lightweight context model while waiting for context information from another lightweight context model for another input portion. In some implementations, concurrent actions include providing one input portion of the multimodal input to a lightweight context model after context information for another input portion has been received from another lightweight context model. In these instances, the actions are concurrent if they occur within a threshold time of each other (e.g., a half-second, a second, or a few seconds) and are independent of each other. For example, providing the first input portion to the first mode lightweight context model 440 is independent and not dependent on providing the second input portion to the second mode lightweight context model 450, even though both actions are seeking to obtain context information for the query request.

Act 412 includes the lightweight image query system 206 generating and providing a prompt that combines the semantic information and the grounding information to the lightweight LGM 460. For example, the lightweight image query system 206 generates a query prompt that includes the semantic information of the query request in the form of converted text as well as grounding information to assist in answering the request. The lightweight image query system 206 then provides the prompt to the lightweight LGM 460. In some implementations, the lightweight image query system 206 also sends a system prompt that provides additional instructions, examples, and guardrails (e.g., responsible artificial intelligence (RAI) rules).

Act 414 includes the lightweight LGM 460 generating and providing a query response based on the prompt to the lightweight image query system 206. For example, following the instructions in the prompt from the lightweight image query system 206 and using the included context information, the lightweight LGM 460 generates a query response to answer the request. Because it is lightweight, in many cases, the lightweight LGM 460 quickly processes the query request to generate a query response. As shown, the lightweight LGM 460 returns the query response to the lightweight image query system 206.

Act 416 includes the lightweight image query system 206 providing the query response to the client device 480 in response to the query request. In some implementations, the lightweight image query system 206 reformats the response from the lightweight LGM 460 before providing it to the client device 480. For instance, the lightweight image query system 206 provides the query response to the client device 480 with instructions on how to display it within a user interface element (e.g., a text overlay), as shown in FIG. 3B. In some implementations, the query response is provided to the client device 480 by generating a visual overlay element that includes the query response and having act 408 display the visual overlay element over the image captured by the client device.

In various implementations, the lightweight image query system 206 performs acts 402-416 within a threshold time (e.g., within five seconds, within ten seconds, or between 5-10 seconds), which may be a fraction of the time needed to receive a response from a heavyweight large generative model. Indeed, by using lightweight models, such as the lightweight context models and the lightweight LGM, the lightweight image query system 206 can obtain context information, generate a prompt with the context information, send the prompt to the lightweight LGM, and receive a generated query request within the threshold time.

In some implementations, the lightweight image query system 206 skips acts 406 and 410. For example, the lightweight image query system 206 attempts to have the lightweight LGM 460 answer the query request with only semantic information (or only grounding information). If the lightweight LGM 460 is unable to do so, the lightweight image query system 206 obtains the missing context information from the lightweight context model to provide it to the lightweight LGM 460 in order to generate a query response.

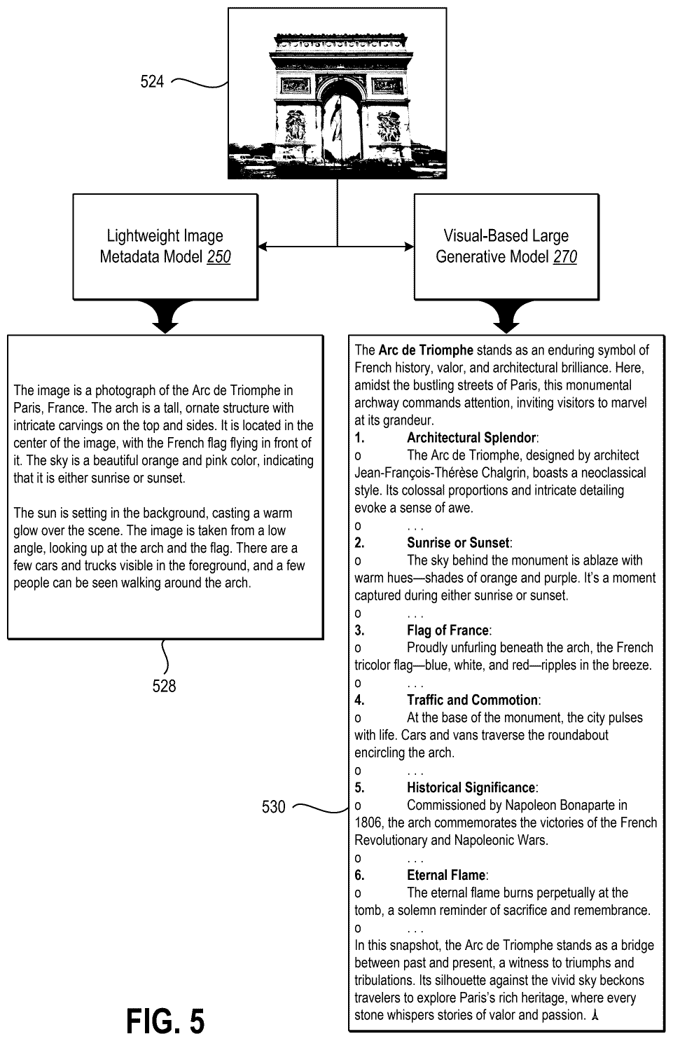

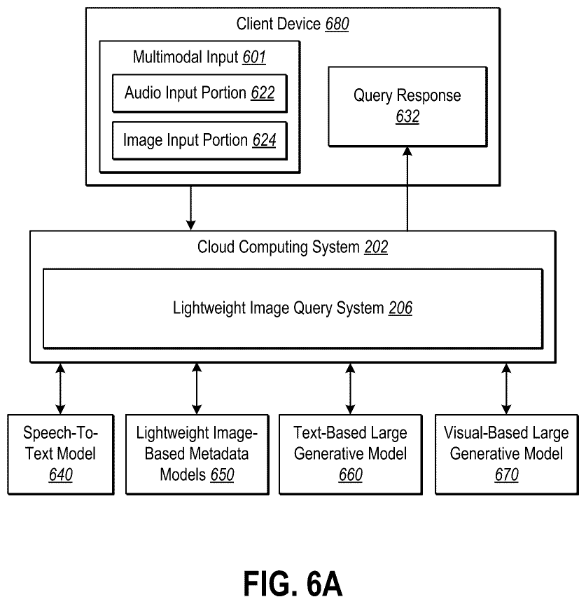

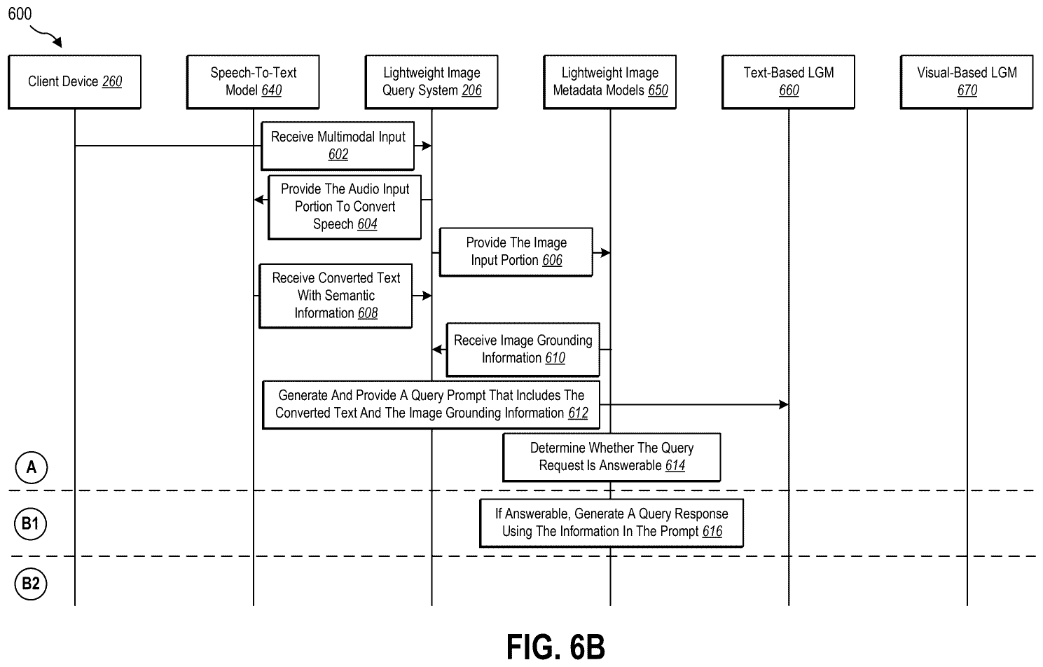

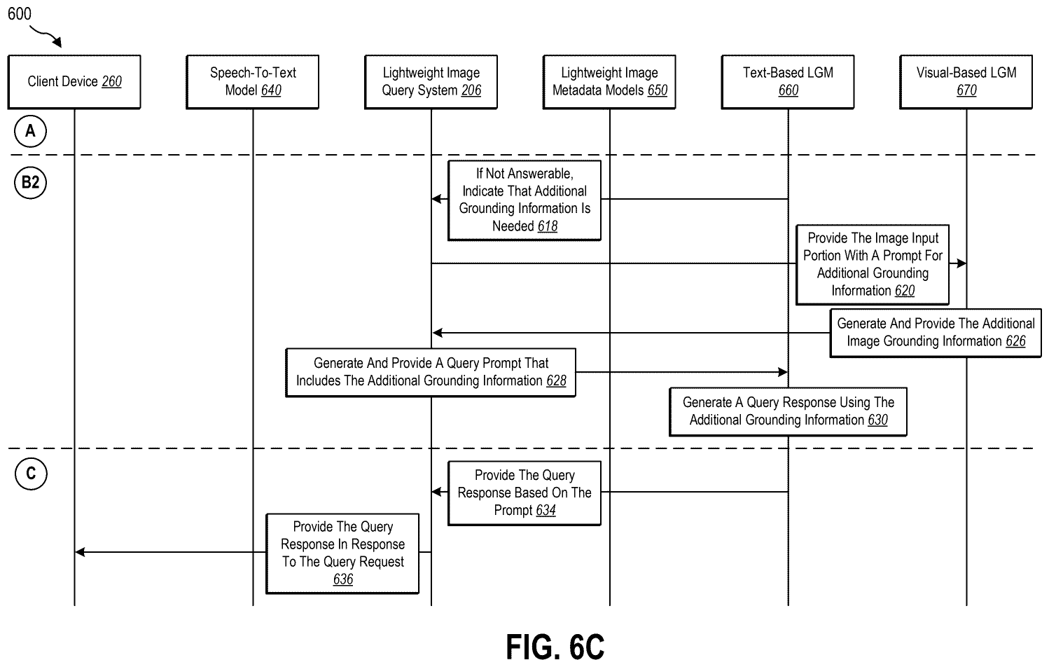

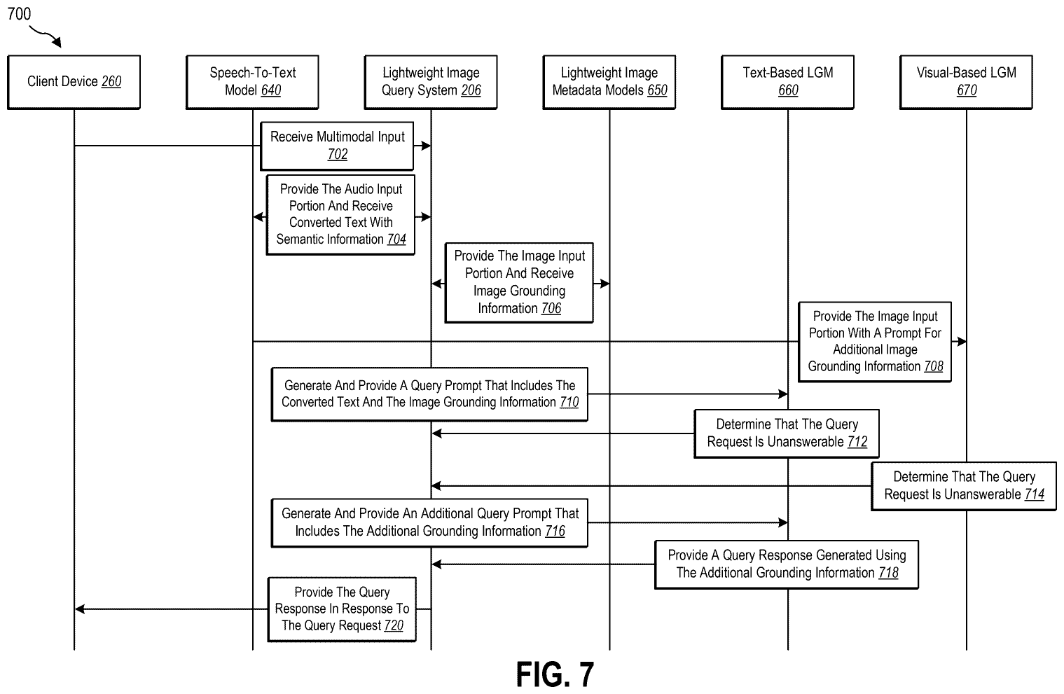

As mentioned above, in some instances, the lightweight LGM may not be able to answer a query request with the grounding information provided by a lightweight context model. In these instances, the lightweight LGM may seek more context information, such as additional grounding information from a heavyweight context model. FIGS. 6A-6C and FIG. 7 illustrate some implementations where additional grounding information is provided to the lightweight LGM. First, however, FIG. 5 shows an example of different outputs from an example lightweight context model versus a heavyweight context model.

To illustrate, FIG. 5 shows an example workflow diagram of using a lightweight and a heavyweight image metadata model to obtain grounding information for an image according to some implementations. As shown, FIG. 5 includes an input image 524, which may represent an image input portion captured as part of a multimodal input. FIG. 5 also includes a lightweight image metadata model 250 and a visual-based large generative model 270 (e.g., a heavyweight context model).

Given the input image 524, the lightweight image metadata model 250 quickly generates (e.g., within 100 milliseconds) a targeted image description 528 with grounding information focused directly on the image. The brevity and crispness of this grounding information transfer into the directness and shortened length of a query response that is based on this focused grounding information.

In various implementations, the lightweight image metadata model 250 does not provide any additional data besides an input image to the lightweight image metadata model 250. Additionally, in various instances, the lightweight image metadata model 250 directly obtains an answer without sending sub-queries to other sources.

In contrast, when the input image 524 (e.g., the same image) is provided to the visual-based large generative model 270, the model generates a lengthy image description 530 that includes both focused and general grounding information. The lengthy image description 530 shown in FIG. 5 has even been shortened and typically includes more information than what is shown. Indeed, the visual-based large generative model 270 takes several seconds and often requires making sub-queries to additional sources.

While the visual-based large generative model 270 provides a comprehensive amount of grounding information, it often provides more information than is necessary to answer a multimodal input query. Therefore, the lightweight image query system 206 can answer query responses in significantly less time by using the lightweight image metadata model 250 instead of the visual-based large generative model 270. However, as described below in connection with FIGS. 6A-6C and FIG. 7, there are some implementations where using the lengthy image description 530 is necessary.

To elaborate, FIGS. 6A-6C illustrate example block and sequence flow diagrams for using multiple lightweight models and, optionally, a heavyweight context model to respond to a multimodal input query request according to some implementations. FIG. 6A includes components and elements involved in generating a query response to a multimodal input query using lightweight models, and, if necessary, a heavyweight context model. FIGS. 6B-6C show a sequence diagram that details actions taken by each component included in FIG. 6A to generate a query response to a multimodal input query.

FIG. 6A is similar to FIG. 4A with different component versions and the addition of a visual-based LGM. To illustrate, FIG. 6A includes the lightweight image query system 206 implemented on the cloud computing system 202, as introduced above. Additionally, FIG. 6A includes a client device 680, a speech-to-text model 640, lightweight image metadata models 650, a text-based LGM 660, and a visual-based LGM 670. These components correspond to similar components introduced in FIG. 2 above. For example, the speech-to-text model 640 and the lightweight image metadata models 650 correspond to the speech-to-text model 240 and the lightweight image metadata model 250.

As shown, the client device 680 includes a multimodal input 601 with an audio input portion 622 and an image input portion 624. The client device 680 provides the multimodal input 601 to the lightweight image query system 206, for example, as part of the multimodal input query. In response, the lightweight image query system 206 uses the speech-to-text model 640, the lightweight image metadata models 650, and, if necessary, the visual-based LGM 670 to obtain context information for the query request.

The lightweight image query system 206 also uses the text-based LGM 660 to generate a query response 632, which the lightweight image query system 206 returns to the client device 680, as shown. FIGS. 6A-6B provide additional details regarding each of these interactions according to some implementations.

With the components and elements in place, FIGS. 6A-6B provide additional detail on how the components interact to generate a query response to a multimodal input query using lightweight models and if needed, a heavyweight context model. As shown, FIGS. 6A-6B include communication between the client device 680, the lightweight large generative model 260, the speech-to-text model 640, the lightweight image metadata models 650, the text-based LGM 660, and/or the visual-based LGM 670.

FIGS. 6A-6B include a series of acts 600 performed by (or for) the lightweight image query system 206. As shown in FIG. 6B, the series of acts 600 includes act 602 of receiving multimodal input from the client device 680. For example, the lightweight image query system 206 receives multimodal input that includes the audio input portion 622 and the image input portion 624.

Act 604 includes providing the audio input portion 622 to the speech-to-text model 640. For example, the lightweight image query system 206 provides the audio input portion 622 to the speech-to-text model 640 to convert the speech in the captured audio to text. In some implementations, a portion of the lightweight image query system 206 is located on the client device 680 and provides the audio input portion 622 to the speech-to-text model 640 from the client device 680.

Act 606 includes providing the image input portion to the lightweight image metadata models 650. For example, the lightweight image query system 206 provides the image input portion 624 to the lightweight image metadata models 650 to quickly and efficiently extract a targeted image description. In some implementations, a portion of the lightweight image query system 206 is located on the client device 680 and provides the image input portion 624 to a lightweight image metadata model directly from the client device 680.

In some implementations, act 606 includes providing the image input portion 624 to one lightweight image metadata model. In some implementations, act 606 includes providing the image input portion 624 to different lightweight image metadata models. For example, the lightweight image query system 206 also provides the image input portion 624 to an image classification model, a similar image search model, an object detection model, an image segmentation model, a text recognition model, and/or a visual search image model to obtain more and/or different grounding information. In these implementations, the lightweight image query system 206 may provide the image input portion 624 to multiple lightweight image metadata models simultaneously.

Act 608 includes the lightweight image query system 206 receiving converted text with semantic information from the speech-to-text model 640. In some implementations, the lightweight image query system 206 causes some or all of the converted text to be displayed on the client device 680. Likewise, act 610 includes the lightweight image query system 206 receiving image grounding information from the lightweight image metadata models 650. As mentioned, the lightweight image query system 206 may receive image grounding information from one or more of the lightweight image metadata models 650. In some implementations, the lightweight image query system 206 causes one or more captured images associated with the image input portion 624 to be displayed on the client device 680.

As mentioned above, the lightweight image query system 206 may perform acts 604 and 608 concurrently with acts 606 and 610. This way, the lightweight image query system 206 obtains context information (e.g., semantic information and grounding information) for the query request as quickly and efficiently as possible.

Act 612 includes the lightweight image query system 206 generating and providing a query prompt that includes the converted text and the image grounding information to the text-based LGM 660. As provided above, the lightweight image query system 206 generates an LGM prompt that includes context information for the query request and provides it to the text-based LGM 660 to answer the query request.

Act 614 includes the text-based LGM 660 determining whether the query request is answerable. For instance, depending on the context and/or semantic information (e.g., the question) in the prompt, the text-based LGM 660 may determine that it is unable to provide an accurate answer because the context information is insufficient. For example, the text-based LGM 660 produces an answer with a certainty score below a certainty threshold (e.g., less than 70% certain the answer is accurate).

To illustrate, briefly returning to FIG. 5, if the query request includes the question “What is this and where is it located?” referencing the input image 524, then the text-based LGM 660 may determine that it can generate an accurate query response given the targeted image description 528 with high confidence. However, if the question is “How many cars are in this image?” referencing the input image 524, then the text-based LGM 660 may determine that the targeted image description 528 is insufficient and additional context information, such as the lengthy image description 530, is needed to accurately answer the question.

Accordingly, in the series of acts 600, Section B1 follows Section A and includes act 616 of the text-based LGM 660 determining that the query request is answerable with the given context information (e.g., the given context information is insufficient) and, in response, generating a query response using the information in the prompt.

Alternatively, in the series of acts 600, Section B2 also follows Section A (shown in FIG. 6C) and includes act 618 of the text-based LGM 660 determining that the query request is not answerable with the given context information and, in response, indicating to the lightweight image query system 206 that additional grounding information is needed. Here, the text-based LGM 660 initially determines that the prompt is insufficient to answer the query request and more context information is needed.

In Section B2, act 620 includes the lightweight image query system 206 providing the image input portion with a prompt to the visual-based LGM 670 for additional grounding information. In some implementations, the lightweight image query system 206 includes the semantic information within the prompt to the visual-based LGM 670. Act 626 includes the visual-based LGM 670 generating and providing the additional image grounding information to the lightweight image query system 206. As described, the additional grounding information may include a wide range of context information associated with a provided image or images.

Also in Section B2, act 628 includes the lightweight image query system 206 generating and providing a query prompt that includes the additional grounding information to the text-based LGM 660. For example, the lightweight image query system 206 updates the previous LGM prompt with the additional grounding information and/or provides the additional grounding information in an additional and/or separate prompt. Section B2 finishes with act 630, which includes the text-based LGM 660 generating a query response using the additional grounding information.

In various implementations, if the text-based LGM 660 determines that the query request is not answerable with the given context information in the first LGM prompt (e.g., the given context information is insufficient), the lightweight image query system 206 may include instructions in the prompt for the text-based LGM 660 to directly query the visual-based LGM 670 (e.g., forward the prompt) to obtain the additional grounding information directly, which may save time, bandwidth, and computing steps. In some instances, the instructions include the visual-based LGM 670 generating and returning an answer directly to the query prompt to the lightweight image query system 206, bypassing the text-based LGM 660.

In one or more implementations, rather than querying the visual-based LGM 670 for the additional grounding information, the lightweight image query system 206 queries additional versions of the lightweight image metadata models 650 for different grounding information. In these implementations, the lightweight image query system 206 may still be able to return a query response in under a threshold time (e.g., under five seconds, under ten seconds, or between 5-10 seconds), which may be a fraction of time needed to receive a response from a heavyweight large generative model.

As shown in FIG. 6C, the series of acts 600 continues to Section C, which follows either Section B1 or Section B2. In Section C, the series of acts 600 includes act 634 of text-based LGM 660 providing the query request to the lightweight image query system 206 based on the prompt. Upon receiving sufficient grounding information, the text-based LGM 660 generates the query request and returns it to the lightweight image query system 206. Act 636 includes the lightweight image query system 206 providing the query response to the client device 680 in response to the query request, as provided above.

FIG. 7 presents another approach that the lightweight image query system 206 may use to generate query requests for multimodal input queries. Specifically, FIG. 7 depicts an example sequence flow diagram for using multiple lightweight models and a heavyweight context model to respond to a multimodal input query request, according to some implementations. Indeed, FIG. 7 highlights scenarios where the lightweight image query system 206 determines to obtain additional grounding information from the visual-based LGM 670 independently of the text-based LGM 660.

FIG. 7 includes the same components as FIGS. 6A-6B. In particular, FIG. 7 includes communication between the client device 680, the lightweight large generative model 260, the speech-to-text model 640, the lightweight image metadata models 650, the text-based LGM 660, and the visual-based LGM 670.

FIG. 7 includes a series of acts 700 performed by (or for) the lightweight image query system 206. As shown, the series of acts 700 includes act 702 of the lightweight image query system 206 receiving the multimodal input. For example, the multimodal input includes an audio input portion and an image input portion, as previously described. Act 704 includes the lightweight image query system 206 providing the audio input portion to the speech-to-text model 640 and receiving converted text with semantic information, as previously described. Act 706 includes the lightweight image query system 206 providing the image input portion to the lightweight image metadata models 650 and receiving image grounding information, as described above.

Act 708 includes the lightweight image query system 206 providing the image input portion with a prompt for additional image grounding information to the visual-based LGM 670. For example, in some implementations, the lightweight image query system 206 determines to obtain additional grounding information early in the process. For example, if the audio input portion 622 is longer than a threshold time or includes more than a threshold number of words, the lightweight image query system 206 determines to query the visual-based LGM 670 for additional grounding information, as previously described.

Act 710 includes the lightweight image query system 206 generating and providing a query prompt that includes the converted text and the image grounding information to the text-based LGM 660, as described above. Act 712 includes the text-based LGM 660 determining that the query request is unanswerable, as described above. As also shown, act 712 includes the text-based LGM 660 indicating the need for additional context information and/or grounding information to answer the query request.

Act 714 includes the visual-based LGM 670 generating and providing the additional image grounding information to the lightweight image query system 206. In some implementations, act 714 occurs before act 712. In some implementations, the lightweight image query system 206 waits for the additional grounding information.

Act 716 includes the lightweight image query system 206 generating and providing an additional query prompt that includes the additional grounding information. As described above, the lightweight image query system 206 may append the additional grounding information to the previously generated LGM prompt, send it separately, or generate a new LGM prompt with the semantic information and the additional grounding information.

In some implementations, the lightweight image query system 206 instructs the visual-based LGM 670 to provide the additional grounding information directly to the text-based LGM 660. In some instances, the lightweight image query system 206 does not send the initial prompt to the text-based LGM 660 until the additional grounding information is received.

Act 718 includes the text-based LGM 660 providing a query response generated using the additional grounding information to the lightweight image query system 206. As described earlier, the text-based LGM 660 uses the additional grounding information to answer the query request and generate a query response. Act 720 includes the lightweight image query system 206 providing the query response to the client device 680 in response to the query request, as described above.

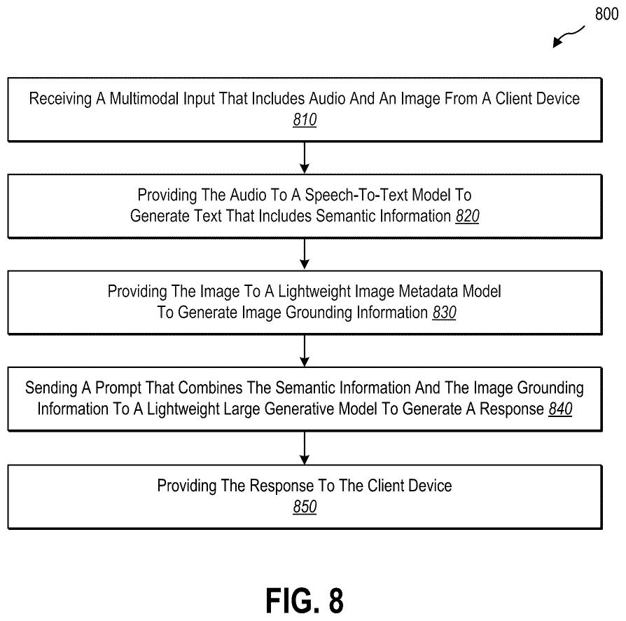

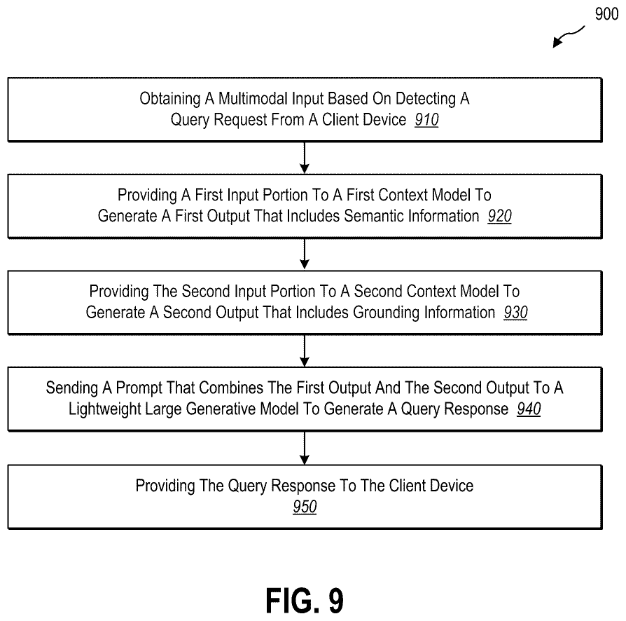

Turning now to FIGS. 8-9, these figures each illustrate an example flowchart that includes a series of acts for using the lightweight image query system. In particular, FIGS. 8-9 each illustrates an example series of acts for responding to multimodal input queries within a threshold time by using multiple lightweight models according to some implementations.

While FIGS. 8-9 each illustrates acts according to one or more implementations, alternative implementations may omit, add to, reorder, and/or modify any of the acts shown. Furthermore, the acts of FIGS. 8-9 can each be performed as part of a method (e.g., a computer-implemented method). Alternatively, a computer-readable medium can include instructions that, when executed by a processing system having a processor, cause a computing device to perform each of the acts of FIGS. 8-9. In some implementations, a system (e.g., a processing system having a processor and a computer memory including instructions that, when executed by the processing system, cause the system to perform various actions or steps) can perform each of the acts of FIGS. 8-9.

As shown in FIG. 8, the series of acts 800 includes act 810 of receiving a multimodal input that includes audio and an image from a client device. For instance, in example implementations, act 810 involves capturing a multimodal input that includes an audio input portion and an image input portion based on detecting a query request from a client device.

As further shown in FIG. 8, the series of acts 800 includes act 820 of providing the audio to a speech-to-text model to generate text that includes semantic information. For instance, in some implementations, act 820 involves providing the audio input portion to a speech-to-text model to generate a converted text string that includes the semantic information (e.g., environment information) of the query request.

As further shown in FIG. 8, the series of acts 800 includes act 830 of providing the image to a lightweight image metadata model to generate image grounding information. For instance, in some implementations, act 830 involves providing the image input portion to a lightweight image metadata model to generate image grounding information of an image captured by the client device. In various implementations, the audio input portion is provided to the speech-to-text model concurrently with the image input portion being provided to the lightweight image metadata model.

As further shown in FIG. 8, the series of acts 800 includes act 840 of sending a prompt that combines the semantic information and the image grounding information to a lightweight large generative model to generate a response. For instance, in example implementations, act 840 involves sending a query prompt that combines the semantic information of the query request and the image grounding information to a lightweight text-based large generative model to generate a query response to the query request.

As further shown in FIG. 8, the series of acts 800 includes act 850 of providing the response to the client device. For instance, in example implementations, act 850 involves providing the query response to the client device in response to the query request. In various implementations, act 850 includes generating a visual overlay element that includes the query response and displaying the visual overlay element over the image captured by the client device. In some instances, the visual overlay element includes text and image links that are included in the query response received from the lightweight text-based large generative model.

As shown in FIG. 9, the series of acts 900 includes act 910 of obtaining a multimodal input based on detecting a query request from a client device. For instance, in example implementations, act 910 involves obtaining a query request from a client device, the query request including multimodal input that includes a first input portion in a first mode and a second input portion in a second mode that is different from the first mode. In some implementations, act 910 includes obtaining a multimodal input that includes a first input portion in a first mode and a second input portion in a second mode that is different from the first mode, based on detecting a query request from a client device. In various implementations, act 910 includes detecting the selection of an input element within a graphical user interface of the client device and capturing the multimodal input by capturing the first input portion and the second input portion together in response to detecting the selection of the input element.

As further shown in FIG. 9, the series of acts 900 includes act 920 of providing a first input portion to a first context model to generate a first output that includes semantic information. For instance, in some implementations, act 920 involves providing the first input portion to a first context model to generate a first output that includes semantic information of the query request, where the first context model is specifically created, trained, or generated (e.g., specialized) to process inputs in a first mode. In various implementations, act 920 includes providing the first input portion to a first lightweight context model to generate a first output that includes semantic information of a query request, the first lightweight context model is specifically created, trained, or generated to process inputs in a first mode. In some implementations, the first input portion includes captured audio, and the first context model includes a speech-to-text model that generates converted text as semantic information.

As further shown in FIG. 9, the series of acts 900 includes act 930 of providing the second input portion to a second context model to generate a second output that includes grounding information. For instance, in some implementations, act 930 involves providing the second input portion to a second context model to generate a second output that includes grounding information, where the second context model is specifically created, trained, or generated to process inputs in a second mode.

In various implementations, act 930 includes providing the second input portion to a second lightweight context model to generate a second output that includes image grounding information, where the second lightweight context model is specifically created, trained, or generated to process inputs in a second mode. In some instances, the second input portion includes a captured image and the second context model includes a lightweight image metadata model that generates descriptive text information of the captured image as image grounding information from input images. In some cases, the first input portion is provided to the first context model concurrently with the second input portion being provided to the second context model.

In some implementations, act 930 includes providing the captured image to one or more additional lightweight image metadata models selected from an image classification model, a similar image search model, an object detection model, an image segmentation model, a text recognition model, or a visual search image model. In some implementations, act 930 includes providing the second input portion to a visual-based large generative model to obtain additional image grounding information and sending the additional image grounding information to the lightweight large generative model. In some instances, the visual-based large generative model takes longer to process images than the second context model. In some instances, the visual-based large generative model receives both text and image input.

In one or more implementations, act 930 includes sending the additional image grounding information to the lightweight large generative model with the prompt. In some implementations, act 930 includes sending the additional image grounding information to the lightweight large generative model in an additional prompt.

As further shown in FIG. 9, the series of acts 900 includes act 940 of sending a prompt that combines the first output and the second output to a lightweight large generative model to generate a query response. For instance, in example implementations, act 940 involves sending a prompt that combines the first output and the second output to a lightweight large generative model to generate a query response to the query request. In one or more implementations, act 940 includes generating the prompt to send to the lightweight large generative model by adding image grounding information from the second output and the semantic information from the first output into a query prompt.

In some implementations, the lightweight large generative model includes a text-based large language model that receives text-only versions of the grounding information and the semantic information to answer the query request. In various instances, the additional prompt is generated based on receiving an indication from the lightweight large generative model, in response to the prompt, that the grounding information is insufficient to answer the query request.

In various implementations, in connection with act 940, the lightweight large generative model initially determines that the prompt is insufficient to answer the query request, the lightweight large generative model provides the query response based on receiving additional image grounding information from a visual-based large generative model, and/or the visual-based large generative model generates the additional image grounding information from the second input portion. In some implementations, in connection with act 940, the lightweight large generative model receives the additional image grounding information from the visual-based large generative model in response to forwarding or sending the prompt to the visual-based large generative model.

As further shown in FIG. 9, the series of acts 900 includes act 950 of providing the query response to the client device. For instance, in example implementations, act 950 involves providing the query response to the client device in response to the query request. In various implementations, the threshold time to provide the query response to the client device in response to the query request is five seconds, ten seconds, or between 5-10 seconds (e.g., a fraction of the time needed to receive a response from a heavyweight large generative model). In one or more implementations, the query response received from the lightweight large generative model includes an answer to the query request without additional metadata (e.g., metadata relevant to the image but beyond the scope of the immediate query request) not being provided to a client device.

FIG. 10 illustrates certain components that may be included within a computer system 1000. The computer system 1000 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1000 represents one or more of the client devices, server devices, or other computing devices described above. For example, the computer system 1000 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1000 includes a processing system including a processor 1001. The processor 1001 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1001 may be referred to as a central processing unit (CPU) and may cause computer-implemented instructions to be performed. Although the processor 1001 shown is just a single processor in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1005 and the data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during the execution of the instructions 1005 by the processor 1001.

A computer system 1000 may also include one or more communication interface(s) 1009 for communicating with other electronic devices. The one or more communication interface(s) 1009 may be based on wired communication technology, wireless communication technology, or both. Some examples of the one or more communication interface(s) 1009 include a Universal Serial Bus (USB), an Ethernet adapter, a wireless adapter that operates according to an Institute of Electrical and Electronics Engineers (IEEE) 1002.11 wireless communication protocol, a Bluetooth® wireless communication adapter, and an infrared (IR) communication port.

A computer system 1000 may also include one or more input device(s) 1011 and one or more output device(s) 1013. Some examples of the one or more input device(s) 1011 include a keyboard, mouse, microphone, remote control device, button, joystick, trackball, touchpad, and light pen. Some examples of the one or more output device(s) 1013 include a speaker and a printer. A specific type of output device that is typically included in a computer system 1000 is a display device 1015. The display device 1015 used with implementations disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For clarity, the various buses are illustrated in FIG. 10 as a bus system 1019.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for responding to multimodal input queries within a threshold time:
obtaining a query request from a client device, the query request including multimodal input that includes a first input portion in a first mode and a second input portion in a second mode that is different from the first mode;
providing the first input portion to a first context model to generate a first output that includes semantic information of the query request, the first context model being specialized to process inputs in a first mode;
providing the second input portion to a second context model to generate a second output that includes grounding information, the second context model being specialized to process inputs in a second mode;
sending a prompt that combines the first output and the second output to a lightweight large generative model to generate a query response to the query request; and
providing the query response to the client device in response to the query request.

2. The computer-implemented method of claim 1, wherein:
the first input portion includes captured audio and the first context model includes a speech-to-text model to generate converted text as semantic information;
the second input portion includes a captured image and the second context model includes a lightweight image metadata model that generates descriptive text information of the captured image as image grounding information from input images; and
the lightweight large generative model includes a text-based large language model that receives text-only versions of the grounding information and the semantic information to answer the query request.

3. The computer-implemented method of claim 2, wherein the first input portion is provided to the first context model concurrently with providing the second input portion to the second context model.

4. The computer-implemented method of claim 2, further comprising providing the captured image to one or more additional lightweight image metadata models selected from an image classification model, a similar image search model, an object detection model, an image segmentation model, a text recognition model, or a visual search image model.

5. The computer-implemented method of claim 1, wherein the threshold time to provide the query response to the client device in response to the query request is half.

6. The computer-implemented method of claim 1, further comprising:
providing the second input portion to a visual-based large generative model to obtain additional image grounding information, wherein the visual-based large generative model takes longer to process images than the second context model, wherein the visual-based large generative model receives both text and image inputs; and
sending the additional image grounding information to the lightweight large generative model.

7. The computer-implemented method of claim 6, further comprising sending the additional image grounding information to the lightweight large generative model with the prompt.

8. The computer-implemented method of claim 6, further comprising sending the additional image grounding information to the lightweight large generative model in an additional prompt.

9. The computer-implemented method of claim 8, wherein the additional prompt is generated based on receiving an indication from the lightweight large generative model, in response to the prompt, that the grounding information is insufficient to answer the query request.

10. The computer-implemented method of claim 1, wherein:
the lightweight large generative model initially determines that the prompt is insufficient to answer the query request;
the lightweight large generative model provides the query response based on receiving additional image grounding information from a visual-based large generative model; and
the visual-based large generative model generates the additional image grounding information from the second input portion.

11. The computer-implemented method of claim 10, wherein the lightweight large generative model receives the additional image grounding information from the visual-based large generative model in response to sending the prompt to the visual-based large generative model.

12. The computer-implemented method of claim 1, further comprising:
detecting a selection of an input element within a graphical user interface of the client device; and
in response to detecting the selection of the input element, capturing the multimodal input by capturing the first input portion and the second input portion together.

13. The computer-implemented method of claim 1, further comprising generating the prompt to send to the lightweight large generative model by including image grounding information from the second output and the semantic information from the first output into a query prompt.

14. A computer-implemented method for responding to multimodal input queries within a threshold time:
based on detecting a query request from a client device, capturing a multimodal input that includes an audio input portion and an image input portion;
providing the audio input portion to a speech-to-text model to generate a converted text string that includes semantic information of the query request;
providing the image input portion to a lightweight image metadata model to generate image grounding information of an image captured by the client device;
sending a query prompt that combines the semantic information of the query request and the image grounding information to a lightweight text-based large generative model to generate a query response to the query request; and
providing the query response to the client device in response to the query request.

15. The computer-implemented method of claim 14, wherein the audio input portion is provided to the speech-to-text model concurrently with providing the image input portion to the lightweight image metadata model.

16. The computer-implemented method of claim 15, wherein providing the query response to the client device comprises:
causing a generation of a visual overlay element that includes the query response; and
causing a display of the visual overlay element over the image captured by the client device.

17. The computer-implemented method of claim 16, wherein the visual overlay element includes text and image links that are included in the query response received from the lightweight text-based large generative model.

18. A system comprising:
a processing system; and
a computer memory comprising instructions that, when executed by the processing system, cause the processing system to perform operations of:
obtaining a multimodal input from a client device that includes a first input portion in a first mode and a second input portion in a second mode that is different from the first mode;
providing the first input portion to a first lightweight large generative model to generate a first output that includes semantic information of a query request, the first lightweight large generative model being generated to process inputs in a first mode;
providing the second input portion to a second lightweight context model to generate a second output that includes image grounding information, the second lightweight context model being generated to process inputs in a second mode;
sending a prompt that combines the first output and the second output to a lightweight large generative model to generate a query response to the query request; and
providing the query response in response to the query request.

19. The system of claim 18, wherein the query response received from the lightweight large generative model includes an answer to the query request without additional metadata not being provided to the client device.

20. The system of claim 18, wherein:
the lightweight large generative model initially determines that the prompt is insufficient to answer the query request;
the lightweight large generative model provides the query response based on receiving additional image grounding information from a visual-based large generative model; and
the visual-based large generative model generates the additional image grounding information from the second input portion.
